(19) United States
(12) Patent Application Publication
(10) Pub. No.: US 2013/0022266 A1
(43) Pub. Date: Jan. 24, 2013

(54) IMAGE PROCESSING METHOD

(71) Applicant: Wei Hsu, Taoyuan County (TW)

(72) Inventor: Wei Hsu, Taoyuan County (TW)

(73) Assignee: NOVATEK MICROELECTRONICS CORP., Hsinchu (TW)

(21) Appl. No.: 13/542,652

(22) Filed: Jul. 5, 2012

(30) Foreign Application Priority Data
Jul. 18, 2011 (TW) 100125297

(51) Int. Cl. G06K 9/00

(52) U.S. Cl. 382/167

(57) ABSTRACT

An image processing method adapted to calculate image data of a pixel array is provided. The pixel array includes a plurality of pixels, and each of the pixels has predetermined elementary color data. The image processing method includes following steps. First, a target pixel of the pixel array is selected. Next, a plurality of first elementary color differences of a plurality of first pixels adjacent to the target pixel are calculated. A part of the first pixels are arranged along a first direction, and another part of the first pixels are arranged along a second direction substantially perpendicular to the first direction. Then, first recovered elementary color data of the target pixel is calculated according to the elementary color differences of the first pixels and the predetermined elementary color data of the target pixel.

### CROSS-REFERENCE TO RELATED APPLICATION

This application claims the priority benefit of Taiwan application serial no. 100125297, filed on Jul. 18, 2011. The entirety of the above-mentioned patent application is hereby incorporated by reference herein and made a part of this specification.

### BACKGROUND OF THE INVENTION

1. Field of the Invention

The invention relates to an image processing method. Particularly, the invention relates to an image processing method used for reconstructing image data.

2. Description of Related Art

Since a charge coupled device (CCD) used for digital image capture can only sense intensity of light and cannot sense a color variation of the light, during digital sampling, a color filter array (CFA) has to be added in front of a sensing substrate.

In occasions that require high image quality, three CCDs are generally used to respectively capture values of red light, green light and blue light of an image, and the three lights are mixed to form a full color image. However, regarding a non-professional or popular image product such as a digital camera, since usage of three CCDs leads to high cost and a large size, a single CCD is generally used, so that each pixel only has a gray value of one of R, G, B color elements. Therefore, in order to obtain a full color image, an interpolation arithmetic operation has to be performed on the result obtained by the sensing substrate to reconstruct the color elements missed by each of the pixels, and then covert the color elements into the digital image.

The commonly used color interpolations include a fixed image interpolation, which is, for example, a nearest interpolation, a bilinear interpolation and a smooth hue transition interpolation. However, since the fixed image interpolation does not have an edge sensing function, a part of an edge line part of the image constructed according to the above method may have an image blur phenomenon, so that the image has a severe noise.

### SUMMARY OF THE INVENTION

The invention is directed to an image processing method, by which image data with good quality is reconstructed.

The invention provides an image processing method adapted to calculate image data of a pixel array. The pixel array includes a plurality of pixels, and each of the pixels has a predetermined elementary color data. The image processing method includes following steps. First, a target pixel of the pixel array is selected. Then, a plurality of first elementary color differences of a plurality of first pixels adjacent to the target pixel are calculated, wherein a part of the first pixels are arranged along a first direction, and another part of the first pixels are arranged along a second direction substantially perpendicular to the first direction. Then, a first recovered elementary color data of the target pixel is calculated according to the first elementary color differences of the first pixels and the predetermined elementary color data of the target pixel.

In an embodiment of the invent ion, the image processing method further includes respectively calculating a first elementary color difference component of the first pixels arranged along the first direction and a second elementary color difference component of the first pixels arranged along the second direction according to the first elementary color differences, and determining a first component weight value of the target pixel corresponding to the first elementary color difference component and the second elementary color difference component according to a mapping relationship.

In an embodiment of the invention, the image processing method further includes following steps. First, a first elementary color sum component of the first pixels arranged along the first direction and a second elementary color sum component of the first pixels arranged along the second direction are calculated according to the first elementary color differences. Then, the first elementary color sum component and the second elementary color sum component are added to obtain a first value, and the first elementary color sum component is subtracted from the second elementary color sum component or the second elementary color sum component is subtracted from the first elementary color sum component to obtain a second value. Then, a first elementary color recovered difference of the target pixel is calculated according to the first value, the second value and the first component weight value. Then, the first recovered elementary color data of the target pixel is obtained by adding the first elementary color recovered difference and the predetermined elementary color data of the target pixel.

In an embodiment of the invention, each of the first elementary color differences is obtained according to the predetermined elementary color data of the corresponding first pixel and the predetermined elementary color data of two pixels located at two opposite sides of the corresponding first pixel.

In an embodiment of the invention, the image processing method further includes following steps. First, a plurality of second elementary color differences of a plurality of second pixels adjacent to the target pixel are calculated, wherein a part of the second pixels are arranged along a third direction, and another part of the second pixels are arranged along a fourth direction substantially perpendicular to the third direction, and an acute angle is formed between the third direction and the first direction. Then, a plurality of second recovered elementary color data of the first pixels are calculated according to the second elementary color differences of the second pixels and the predetermined elementary color data of the first pixels. Then, a plurality of third elementary color differences of the first pixels are calculated. Then, a third recovered elementary color data of the target pixel is calculated according to the third elementary color differences and the first recovered elementary color data of the target pixel.

In an embodiment of the invention, the third elementary color differences of the first pixels are obtained according to the second recovered elementary color data of the first pixels and the predetermined elementary color data of the first pixels.

In an embodiment of the invention, the step of calculating the second elementary color differences of the second pixels includes regarding each of the second pixels as the target pixel to calculate the corresponding first recovered elementary color data of each of the second pixels, and calculating the second elementary color differences of the second pixels according to the first recovered elementary color data of the second pixels and the predetermined elementary color data of the second pixels.

In an embodiment of the invention, the step of calculating the second recovered elementary color data of the target pixel includes calculating a fourth elementary color difference of the target pixel according to the third elementary color differences, and obtaining the second recovered elementary color data by subtracting the fourth elementary color difference from the first recovered elementary color data of the target pixel.

In an embodiment of the invention, the step of calculating the fourth elementary color difference of the target pixel includes following steps. A third elementary color difference component of the first pixels arranged along the first direction and a fourth elementary color difference component of the first pixels arranged along the second direction are calculated according to the third elementary color differences. Then, a second component weight value of the target pixel corresponding to the third elementary color difference component and the fourth elementary color difference component is determined according to a mapping relationship.

In an embodiment of the invention, the image processing method further includes following steps. A third elementary color sum component of the first pixels arranged along the first direction and a fourth elementary color sum component of the first pixels arranged along the second direction are calculated according to the third elementary color differences. Then, the third elementary color sum component and the fourth elementary color sum component are added to obtain a third value, and the third elementary color sum component is subtracted from the fourth elementary color sum component or the fourth elementary color sum component is subtracted from the third elementary color sum component to obtain a fourth value. Then, the fourth elementary color difference of the target pixel is calculated according to the third value, the fourth value and the second component weight value.

In an embodiment of the invention, the image processing method further includes following steps. One of the first pixels is selected. Then, a fourth recovered elementary color data of the first pixel is calculated according to the predetermined elementary color data of the selected first pixel and two fifth elementary color differences of two pixels located at two opposite sides of the selected first pixel.

In an embodiment of the invention, the image processing method further includes following steps. The two pixels located at two opposite sides of the selected first pixel are respectively regarded as the target pixel to respectively calculate the corresponding first recovered elementary color data of the two pixels. Then, the two fifth elementary color differences are calculated according to the predetermined elementary color data of the two pixels and the first recovered elementary color data of the two pixels.

In an embodiment of the invention, the first recovered elementary color data corresponds to green color data.

According to the above descriptions, by calculating a plurality of first elementary color differences of the pixels adjacent to the target pixel and using the the predetermined elementary color data of the target pixel, the first recovered elementary color data of the target pixel is calculated. In this way, image data with good quality is reconstructed, and unnecessary image noise is reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 are schematic diagrams illustrating an image processing method according to an embodiment of the invention.

FIG. 3A and FIG. 3B are schematic diagrams of reconstructing a recovered elementary color data of a pixel adjacent to a target pixel.

FIG. 4A is a flowchart illustrating an image processing method of FIG. 1.

FIG. 4B is a detailed flowchart of step S130 of FIG. 4A.

FIG. 5 is a diagram illustrating a mapping relationship of step S132 of FIG. 4B used for determining a component weight value of the target pixel.

FIG. 6 is flowchart of an image processing method of FIG. 2.

FIG. 7 is a flowchart illustrating an image processing method of FIG. 3A and FIG. 3B.

### DETAILED DESCRIPTION OF DISCLOSED EMBODIMENTS

In the following embodiments, a 5×7 pixel array is taken as an example for descriptions, though those skilled in the art should understand that the 5×7 pixel array is not used to limit the image processing method of the invention.

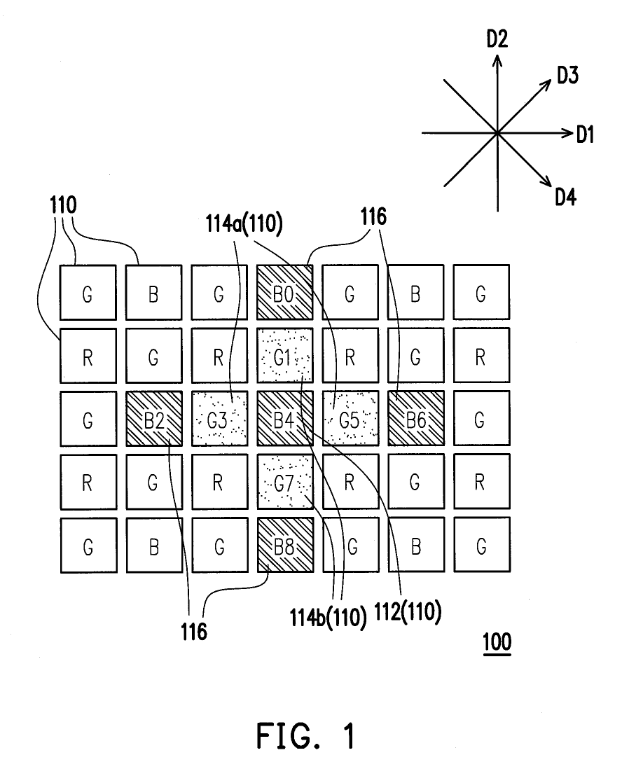

FIG. 1 to FIG. 3B are schematic diagrams illustrating an image processing method according to an embodiment of the invention. The image processing method of the present embodiment is adapted to calculate image data of a pixel array. In other words, the image processing method of the present embodiment can be applied on image products such as an image sensor, an image signal processor of a mobile phone and a digital camera, etc. Referring to FIG. 1, the pixel array 100 of the present embodiment includes a plurality of pixels 110, and the pixel array 100 is, for example, a 5×7 pixel array, i.e. the image processing method of the present embodiment is adapted to an image processing device with a five-lines buffer. Therefore, the image processing method of the present embodiment can achieve an effect of reconstructing image data of the pixel array without increasing a memory capacity, and details thereof are described later.

As shown in FIG. 1, each of the pixels 110 has a predetermined elementary color data. In detail, in the present embodiment, R, G, B, B0, G1, B2, G3 marked on the pixels 110 represents the predetermined elementary color data of the pixels 110, where the predetermined elementary color data R, for example, corresponds to red color data, predetermined elementary color data G, G1, G3, G5 and G7, for example, correspond to green color data, and predetermined elementary color data B, B0, B2, B4, B6 and B8, for example, correspond to blue color data. Moreover, a ratio of batch numbers of the green color data, the blue color data and the red color data is 2:1:1, and such arrangement method is generally referred to as a Bayer pattern. In the image processing method of the present embodiment, an arithmetic operation of interpolation is performed to reconstruct elementary color data missed by each pixel 110.

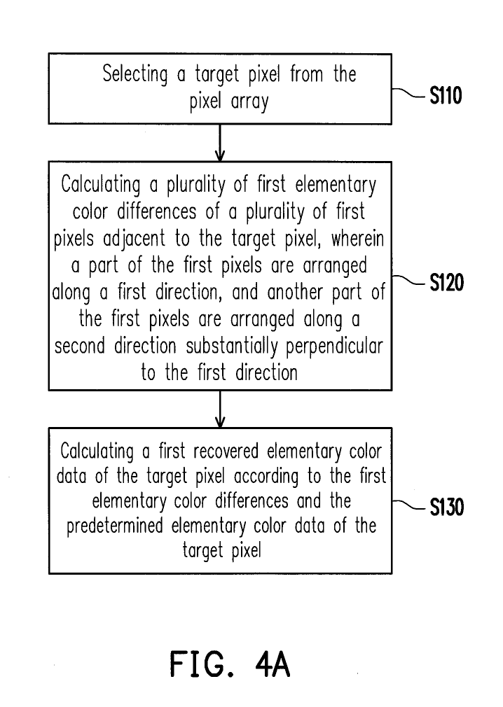

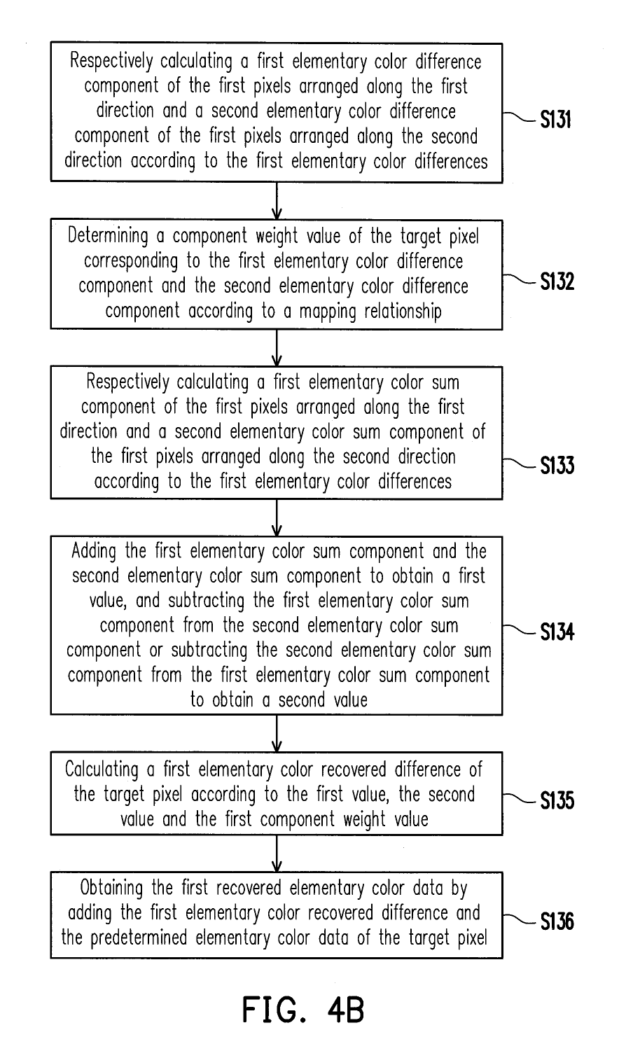

FIG. 1 is a schematic diagram of reconstructing recovered an elementary color data G4 of a target pixel 112, and FIG. 4A is flowchart of the image processing method of FIG. 1, where the target pixel 112 of FIG. 1 has the predetermined elementary color data B4. In the present embodiment, the predetermined elementary color data B4 corresponds to blue color data, and the recovered elementary color data G4 corresponds to green color data. The image processing method of the present embodiment for reconstructing the recovered elementary color data G4 of the target pixel 112 is described below.

Referring to FIG. 1 and FIG. 4A, the target pixel 112 of the pixel array 110 is selected (step S110), where the target pixel 112 has the predetermined elementary color data B4, and is, for example, located in the middle of the pixel array 100. Then, a plurality of elementary color differences Kb1, Kb3, Kb5 and Kb7 of a plurality of pixels 114a and 114b adjacent to the target pixel 112 are calculated, wherein a part of the pixels 114a are arranged along a direction D1, and another part of the pixels 114b are arranged along a direction D2 substantially perpendicular to the direction D1 (step S120). In the present embodiment, the elementary color differences Kb1, Kb3, Kb5 and Kb7 can be respectively represented by following equations:

Kb1=G1−(B0+B4)/2 (1)

Kb3=G3−(B2+B4)/2 (2)

Kb5=G5−(B6+B4)/2 (3)

Kb7=G7−(B8+B4)/2 (4)

Where, G1 and G7 are respectively the predetermined elementary color data of the pixels 114b, and G3 and G5 are respectively the predetermined elementary color data of the pixels 114a, and B0, B2, B6 and B8 are respectively the predetermined elementary color data of pixels 116. According to the above equations, it is known that each of the elementary color differences Kb1, Kb3, Kb5 and Kb7 is obtained according to the predetermined elementary color data G1, G3, G5 and G7 of the pixel 114a or 114b and the predetermined elementary color data (for example, the predetermined elementary color data B0 and B4, B2 and B4, B6 and B4 or B8 and B4) of two pixels located at two opposite sides of the pixel 114a or 114b. As shown in FIG. 1, the pixels 114a are located between the target pixel 112 and the pixels 116, and the pixels 114b are located between the target pixel 112 and the pixels 116. In the present embodiment, the elementary color differences Kb1, Kb3, Kb5 and Kb7 represent differences of green color data and blue color data. Moreover, the predetermined elementary color data B4 of the target pixel 112 and the predetermined elementary color data B0, B2, B6 and B8 of the pixels 116 all correspond to data of the same color (i.e. the blue color data).

Then, the recovered elementary color data G4 of the target pixel 112 is calculated according to the elementary color differences Kb1, Kb3, Kb5 and Kb7 and the predetermined elementary color data B4 of the target pixel 112 (step S130), where the recovered elementary color data G4 corresponds to green color data. FIG. 4B is a detailed flowchart of the step S130 of FIG. 4A. In the present embodiment, the step S130 of FIG. 4A includes sub steps S131-S136. Referring to FIG. 1 and FIG. 4B, an elementary color difference component Ct of the pixels 114a arranged along the direction D1 and an elementary color difference component Cy of the pixels 114b arranged along the direction D2 are respectively calculated according to the elementary color differences Kb1, Kb3, Kb5 and Kb7 (step S131). The elementary color difference components Cy and Ct can be respectively represented by following equations:

Cy=|Kb1−Kb7|/Div (5)

Ct=|Kb3−Kb5|/Div (6)

Where, Div is a variable related to a shift bit number, and in the present embodiment, the variable Div is equal to 4 in color difference calculation and is equal to 2 in native data calculation.

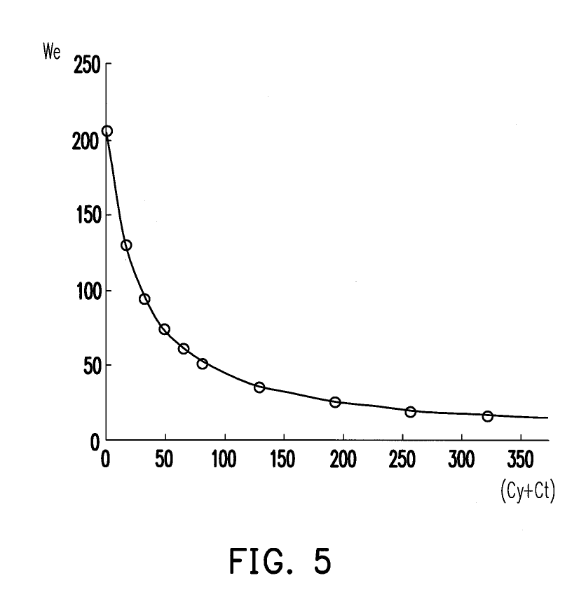

Then, a component weight value We of the target pixel 112 corresponding to the elementary color difference component Cy and the elementary color difference component Ct is determined according to a mapping relationship (step S132). FIG. 5 is a diagram illustrating the mapping relationship of the step S132 of FIG. 4B used for determining the component weight value We of the target pixel 112. In the present embodiment, the mapping relationship diagram can be implemented by a mapping table, and the mapping table is, for example, a weighting table, which is used for determining the component weight value We according to the sum of the elementary color difference components Cy and Ct (i.e. (Cy+Ct)).

As shown in FIG. 5, the sum (Cy+Ct) of the elementary color difference components Cy and Ct is inversely proportional to the component weight value We. Namely, the smaller the sum (Cy+Ct) of the elementary color difference components is, the greater the component weight value We is, and the greater the sum (Cy+Ct) is, the smaller the component weight value We is. Herein, the greater the elementary color difference component Cy is, the greater the difference between the elementary color differences Kb1 and Kb7 of the upper and lower pixels 114b of the target pixel 112 of FIG. 1 is. In other words, the pixels 114b marked as the predetermined elementary color data G1 and G7 in FIG. 1 are probably located at a boundary (for example, an edge of an image) with a larger gray level difference, and in the present embodiment, unnecessary noise or error recovery is reduced by reducing the component weight value We used for calculating the recovered elementary color data G4 of the target pixel 112. Similarly, the greater the elementary color difference component Ct is, the greater the difference between the elementary color differences Kb3 and Kb5 of the left and right pixels 114a of the target pixel 112 of FIG. 1 is. Namely, the pixels 114a marked as the predetermined elementary color data G3 and G5 in FIG. 1 are probably located at the boundary with a larger gray level difference, and in the present embodiment, unnecessary noise or error recovery is reduced by reducing the component weight value We used for calculating the recovered elementary color data G4 of the target pixel 112. In other words, the image processing method of the present embodiment can provide an edge sensing function to reduce unnecessary noise or a chance of error recovery.

Moreover, as shown in FIG. 5, since the sum (Cy+Ct) of the elementary color difference components and the component weight value We have a single function relationship, the aforementioned mapping relationship is adapted to be implemented by a hardware form. Namely, the mapping relationship can be implemented by repeatedly using a hardware module. Besides, in the image processing method of the embodiment, since the corresponding component weight value We can be calculated according to the mapping relationship diagram in collaboration with a linear interpolation method, when the linear interpolation with a horizontal axis space of a power of 2 is used, it is also adapted to hardware implementation. In other words, in the present embodiment, suitable component weight value We is calculated according to the aforementioned mapping relationship and the interpolation method.

Referring to FIG. 1 and FIG. 4B, an elementary color sum component (Kb3+Kb5) of the pixels 114a arranged along the direction D1 and an elementary color sum component (Kb1+Kb7) of the pixels 114b arranged along the direction D2 are respectively calculated according to the elementary color differences Kb1, Kb3, Kb5 and Kb7 (step S 133). In detail, the pixels 114a respectively have the predetermined elementary color data G3 and G5 and respectively correspond to the elementary color differences Kb3, Kb5, and the pixels 114b respectively have the predetermined elementary color data G1 and G7 and respectively correspond to the elementary color differences Kb1, Kb7.

Then, the elementary color sum component (Kb3+Kb5) and the elementary color sum component (Kb1+Kb7) are respectively added to obtain a first value Gp1, and the elementary color sum component (Kb3+Kb5) is subtracted from the elementary color sum component (Kb1+Kb7) or the elementary color sum component (Kb1+Kb7) is subtracted from the elementary color sum component (Kb3+Kb5) to obtain a second value Gp2 (step S134). The first value Gp1 and the second value Gp2 can be represented by following equations:

Gp1=(Kb3+Kb5)+(Kb1+Kb7) (7)

Gp2=(Kb3+Kb5)−(Kb1+Kb7) (8)

Then, an elementary color recovered difference Kb4 of the target pixel 112 is calculated according to the first value Gp1, the second value Gp2 and the component weight value We obtained according to the mapping relationship (step S135), where the elementary color recovered difference Kb4 can be represented by a following equation:

Kb4=(Gp1+(Gp2×Tx)÷32)÷4 (9)

Where, Tx in the equation (9) is a variable, which can be represented as Tx=(Cy−Ct)×We÷64, and values 32, 4 and 64 in the equations can all be adjusted according to an actual hardware design, and the invention is not limited thereto. In other words, a concept presented by the equations (7)-(9) is that the elementary color recovered difference Kb4 of the target pixel 112 is related to the elementary color sum component (Kb3+Kb5) of the adjacent pixels 114a and the elementary color sum component (Kb1+Kb7) of the adjacent pixels 114b, where the elementary color recovered difference Kb4, for example, represents a difference of the green color data and the blue color data.

Then, after the elementary color recovered difference Kb4 of the target pixel 112 is calculated, the elementary color recovered difference Kb4 is added with the predetermined elementary color data B4 of the target pixel 112 to obtain the recovered elementary color data G4 (step S136), i.e. G4=B4+Kb4. In this way, the first recovered elementary color data G4 of the target pixel 112 is reconstructed, and the recovered elementary color data G4 corresponds to the green color data. In brief, in the step S130 and the sub steps S131-S136 of the image processing method of the present embodiment, the green data (i.e. the predetermined elementary color data G1, G7, G3 and G5) corresponding to the upper and lower pixels 114b and the left and right pixels 114a of the target pixel 112 are used to recover the green color data (i.e. the recovered elementary color data G4) of the target pixel 112.

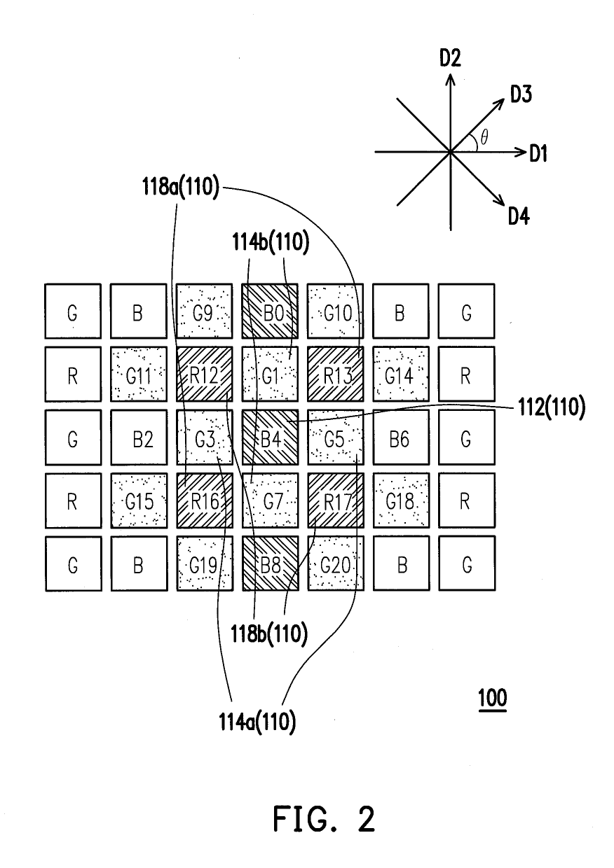

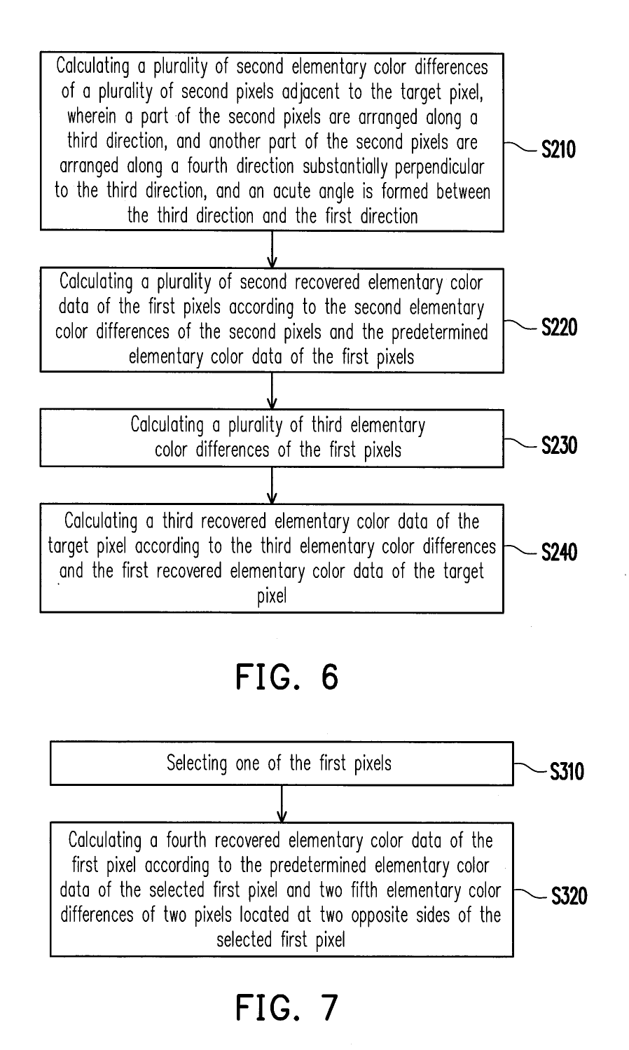

FIG. 2 is a schematic diagram of reconstructing another recovered elementary color data R4 of the target pixel 112, and FIG. 6 is flowchart of the image processing method of FIG. 2, where the target pixel 112 of FIG. 2 has the predetermined elementary color data B4 and the recovered elementary color data G4 reconstructed through the steps S110-S130. The image processing method of the present embodiment for reconstructing the other recovered elementary color data R4 of the target pixel 112 is described below.

Referring to FIG. 2 and FIG. 6, a plurality of elementary color differences Kr12, Kr13, Kr16 and Kr17 of a plurality of pixels 118a and 118b adjacent to the target pixel 112 are calculated, wherein a part of the pixels 118a are arranged along a direction D3, and another part of the pixels 118b are arranged along a direction D4 substantially perpendicular to the direction D3 (step S210), and an acute angle θ is formed between the direction D3 and the direction D1. In the present embodiment, the acute angle θ is, for example, 45 degrees, and the elementary color differences Kr12, Kr13, Kr16 and

Kr17 can be respectively represented by following equations:

Kr12=G12−R12 (10)

Kr13=G13−R13 (11)

Kr16=G16−R16 (12)

Kr17=G17−R17 (13)

Where, G12 and G17 are respectively the recovered elementary color data of the pixels 118b of FIG. 2, and R12 and R17 are respectively the predetermined elementary color data of the pixels 118b. G13 and G16 are respectively recovered elementary color data of the pixels 118a of FIGS. 2, and R13 and R16 are respectively the predetermined elementary color data of the pixels 118a. In the present embodiment, the recovered elementary color data G12, G13, G16 and G17 represent green color data, the predetermined elementary color data R12, R13, R16 and R17 represent red color data, and the elementary color differences Kr12, Kr13, Kr16 and Kr17 represent differences of the green color data and the red color data. Moreover, the recovered elementary color data G12, G13, G16 and G17 of the pixels 118a and 118b are calculated according to the steps shown in FIG. 4A and FIG. 4B.

Further, the recovered elementary color data G12 of the upper left pixel 118b of FIG. 2 is obtained according to the predetermined elementary color data G9, G11, G3 and G1 of the pixels 110, the recovered elementary color data G13 of the upper right pixel 118a of FIG. 2 is obtained according to the predetermined elementary color data G10, G1, G5 and G14 of the pixels 110, the recovered elementary color data G16 of the lower left pixel 118a of FIG. 2 is obtained according to the predetermined elementary color data G3, G15, G19 and G7 of the pixels 110, and the recovered elementary color data G17 of the lower right pixel 118b of FIG. 2 is obtained according to the predetermined elementary color data G5, G7, G20 and G18 of the pixels 110.

In other words, the method of calculating the elementary color differences Kr12, Kr13, Kr16 and Kr17 of the pixels 118a and 118b includes following steps. The pixels 118a and 118b are respectively regarded as the target pixel 112 of FIG. 1 to calculate the recovered elementary color data G12, G13, G16 and G17 respectively corresponding to the pixels 118a and 118b. Then, the elementary color differences Kr12, Kr13, Kr16 and Kr17 of the pixels 118a and 118b are calculated according to the recovered elementary color data G12, G13, G16 and G17 of the pixels 118a and 118b and the predetermined elementary color data R12, R13, R16 and R17 of the pixels 118a and 118b. Since the method of calculating the recovered elementary color data G12, G13, G16 and G17 can be deduced according to the related descriptions of FIG. 1 and FIG. 4A-FIG. 4B, details thereof are not repeated.

Then, a plurality of recovered elementary color data R1, R3, R5 and R7 of the pixels 114a and 114b are calculated according to the elementary color differences Kr12, Kr13, Kr16 and Kr17 of the pixels 118a and 118b and the predetermined elementary color data G1, G3, G5 and G7 of the pixels 114a and 114b (step S220). In the present embodiment, the recovered elementary color data R3 and R5 of the pixels 114a and the recovered elementary color data R1 and R7 of the pixels 114b can be respectively represented as following equations:

R1=G1−(Kr12+Kr13)/2 (14)

R3=G3−(Kr12+Kr16)/2 (15)

R5=G5−(Kr13+Kr17)/2 (16)

R7=G7−(Kr16+Kr17)/2 (17)

Then, a plurality of elementary color differences Kr1, Kr3, Kr5 and Kr7 of the pixels 114a and 114b are calculated (step S230). In the present embodiment, the elementary color differences Kr1, Kr3, Kr5 and Kr7 are respectively represented by following equations:

Kr1=G1−R1 (18)

Kr3=G3−R3 (19)

Kr5=G5−R5 (20)

Kr7=G7−R7 (21)

In other words, the elementary color differences Kr1, Kr3, Kr5 and Kr7 of the pixels 114a and 114b are obtained according to the recovered elementary color data R3, R5, R1 and R7 of the pixels 114a and 114b and the predetermined elementary color data G3, G5, G1 and G7 of the pixels 114a and 114b. Similarly, the elementary color differences Kr1, Kr3, Kr5 and Kr7 represents differences of the green color data and the red color data.

Finally, the other recovered elementary color data R4 of the target pixel 112 is calculated according to the elementary color differences Kr1, Kr3, Kr5 and Kr7 and the recovered elementary color data G4 of the target pixel 112 obtained according to the step S130 (step S240). In the present embodiment, the recovered elementary color data R4 can be represented by a following equation:

R4=G4−Kr4 (22)

Where, Kr4 is another elementary color difference of the target pixel 112, and the elementary color difference Kr4 represents a difference of the green color data and the red color data. In the present embodiment, the method of calculating the elementary color difference Kr4 of the target pixel 112 includes following steps. First, the elementary color difference component Ct of the pixels 114a arranged along the direction Dl and the elementary color difference component Cy of the pixels 114b arranged along the direction D2 are respectively calculated according to the elementary color differences Kr1, Kr3, Kr5 and Kr7. Namely, the elementary color differences Kb1, Kb3, Kb5 and Kb7 of the equations (5) and (6) are respectively replaced by the elementary color differences Kr1, Kr3, Kr5 and Kr7.

Then, another component weight value We of the target pixel 112 corresponding to the elementary color difference component Cy and the elementary color difference component Ct is determined according to the mapping relationship of FIG. 5. Then, an elementary color sum component (Kr3+Kr5) of the pixels 114a arranged along the direction D1 and an elementary color sum component (Kr1+Kr7) of the pixels 114b arranged along the direction D2 are respectively calculated according to the elementary color differences Kr1, Kr3, Kr5 and Kr7. Then, the elementary color sum component (Kr3+Kr5) and the elementary color sum component (Kr1+Kr7) are respectively added and subtracted to obtain a third value Gp3 and a fourth value Gp4. The third value Gp3 and the fourth value Gp4 can be represented by following equations:

Gp3=(Kr3+Kr5)+(Kr1+Kr7) (23)

Gp4=(Kr3+Kr5)−(Kr1+Kr7) (24)

Then, an elementary color difference Kr4 of the target pixel 112 is calculated according to the third value Gp3, the fourth value Gp4 and the component weight value We obtained according to the mapping relationship, where the elementary color difference Kr4 can be represented by a following equation:

Kr4=(Gp3+(Gp4×Tx)÷32)÷4 (25)

Where, Tx in the equation (25) is a variable, which can be represented as Tx=(Cy−Ct)×We÷64, and values 32, 4 and 64 in the equations can all be adjusted according to an actual hardware design, and the invention is not limited thereto. In other words, the elementary color difference Kr4 of the target pixel 112 is obtained according to the elementary color differences Kr1, Kr3, Kr5 and Kr7 of the pixels 114a and 114b, and the elementary color difference Kr4 is calculated according to steps similar to the steps shown in FIG. 4A and FIG. 4B. Since the method of calculating the elementary color difference Kr4 can be deduced according to the related descriptions of FIG. 1 and FIG. 4A-FIG. 4B, details thereof are not repeated.

According to the above descriptions, the method of calculating the other recovered elementary color data R4 of the target pixel 112 is to calculate the elementary color difference Kr4 of the target pixel 112 according to the elementary color differences Kr1, Kr3, Kr5 and Kr7, and subtract the elementary color difference Kr4 from the reconstructed recovered elementary color data G4 of the target 112 to obtain the other recovered elementary color data R4 (as shown by equation (22)).

In this way, the second recovered elementary color data R4 of the target pixel 112 is reconstructed, and the recovered elementary color data R4 corresponds to the red color data. In overall, during the process of reconstructing the recovered elementary color data R4, the image processing method of the present embodiment first calculates the recovered elementary color data R1 and R7 of the upper and lower pixels 114b and the recovered elementary color data R3 and R5 of the left and right pixels 114a (i.e. the steps S210 and S220), and then reconstructs the other recovered elementary color data R4 according to the calculated recovered elementary color data R1, R3, R5 and R7 (steps S230 and S240). In this way, the target pixel 112 originally having the predetermined elementary color data B4 (corresponding to the blue color data) only may now simultaneously have the red, blue and green color data, so that the target pixel 112 can display a full color image.

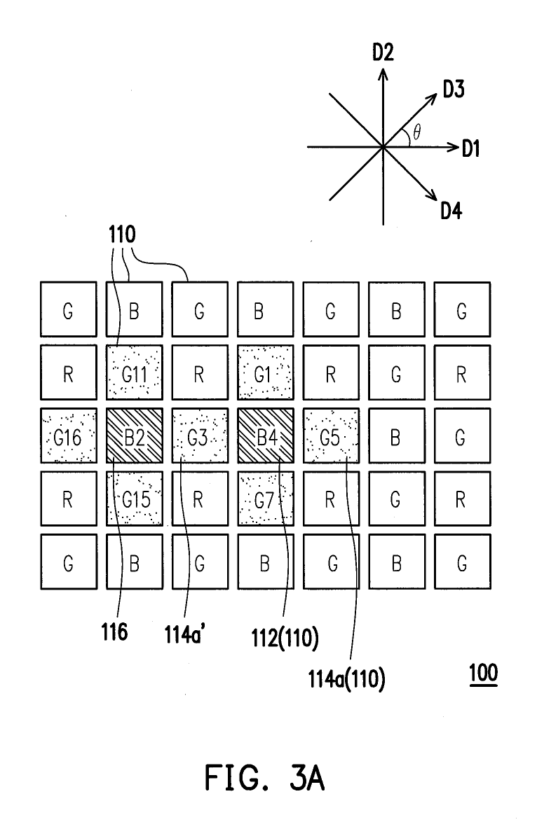

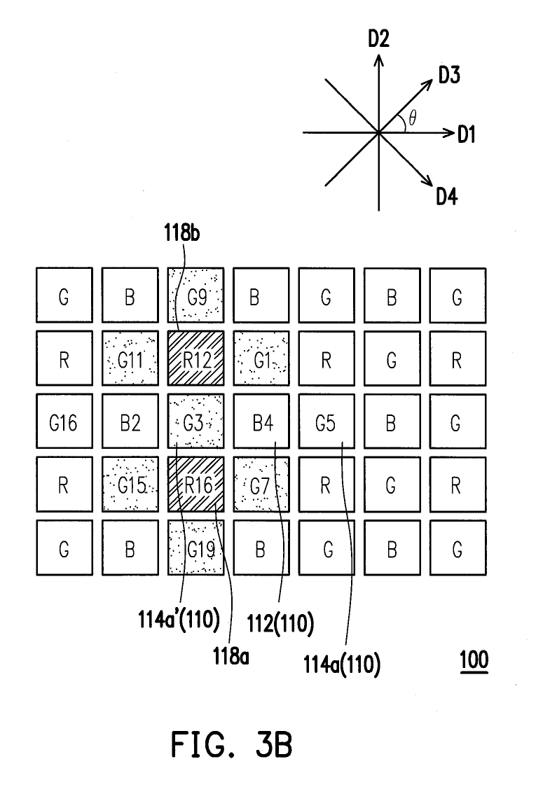

FIGS. 3A and 3B are schematic diagram of reconstructing recovered elementary color data of a pixel 114a′ adjacent to the target pixel 112. FIG. 7 is a flowchart illustrating an image processing method of FIG. 3A and FIG. 3B. The pixel 114a′ in FIG. 3A and FIG. 3B has the predetermined elementary color data G3, and the target pixel 112 has the predetermined elementary color data B4 and the reconstructed recovered elementary color data G4. The image processing method for reconstructing the recovered elementary color data of the pixel 114a′ adjacent to the target pixel 112 is described below.

In the present embodiment, FIG. 3A is a schematic diagram of reconstructing recovered elementary color data B3 of the pixel 114a′. Referring to FIG. 3A and FIG. 7, first, one of the pixels 114a is selected (for example, the pixel 114a′) (step S310). Then, the recovered elementary color data B3 of the pixel 114a′ is calculated according to the predetermined elementary color data G3 of the selected pixel 114a′ and two elementary color differences Kb2 and Kb4 of two pixels 116 and 112 located at two opposite sides (for example, left and right sides) of the selected pixel 114a′ (step S320). In the present embodiment, the elementary color differences Kb2 and Kb4 and the recovered elementary color data B3 of the pixel 114a′ can be respectively represented by following equations:

Kb2=B2−G2 (260

Kb4=B4−G4 (27)

B3=G3+(Kb2+Kb4)/2 (28)

Where, B2 and B4 are respectively predetermined elementary color data of the pixel 116 and the target pixel 112, G2 and G4 are recovered elementary color data of the pixel 116 and the target pixel 112, and the predetermined elementary color data B2 and B4 represent blue color data, and the recovered elementary color data G2 and G4 represent green color data. Moreover, the recovered elementary color data G2 of the pixel 116 is calculated according to the steps shown in FIG. 4A and FIG. 4B. Further, the recovered elementary color data G2 of the pixel 116 is calculated according to the predetermined elementary color data G11, G16, G15 and G3 of the pixels 110. Namely, the pixel 116 located at the left side of the pixel 114a′ is regarded as the target pixel 112 of FIG. 1, and the recovered elementary color data G2 of the pixel 116 is calculated according to the steps shown in FIG. 4A and FIG. 4B. Since the method of calculating the recovered elementary color data G2 can be deduced according to the related descriptions of FIG. 1 and FIG. 4A-FIG. 4B, details thereof are not repeated.

Then, the elementary color differences Kb2 and Kb4 are calculated according to the predetermined elementary color data B2 and B4 of the pixels 116 and the target pixel 112 and the recovered elementary color data G2 and G4 of the pixels 116 and the target pixel 112 (as shown by equations (26) and (27)). Then, the recovered elementary color data B3 of the pixel 114a′ is calculated according to the elementary color differences Kb2 and Kb4 and the predetermined elementary color data G3 of the pixel 114a′.

In other words, in the image processing method of the present embodiment, the elementary color differences Kb2 and Kb4 are calculated according to the predetermined elementary color data B2 and B4 of the pixels 116 and the target pixel 112 and the recovered elementary color data G2 and G4 of the pixels 116 and the target pixel 112, where the elementary color differences Kb2 and Kb4 represent differences of blue color data and green color data. Then, the recovered elementary color data B3 of the pixel 114a′ is calculated according to the predetermined elementary color data G3 of the pixel 114a′ and the elementary color differences Kb2 and Kb4 of two pixels adjacent to the pixel 114a′. In this way, the recovered elementary color data B3 of the pixel 114a′ is reconstructed, and the recovered elementary color data B3 of the present embodiment, for example, corresponds to blue color data.

FIG. 3B is a schematic diagram of reconstructing another recovered elementary color data R3 of the pixel 114a′. Referring to FIG. 3B and FIG. 7, first, one of the pixels 114a is selected (for example, the pixel 114a′) (step S310). Then, the recovered elementary color data R3 of the pixel 114a′ is calculated according to the predetermined elementary color data G3 of the selected pixel 114a′ and two elementary color differences Kr12 and Kr16 of two pixels 118b and 118a located at two opposite sides (for example, upper and lower sides) of the selected pixel 114a′ (step S320). In the present embodiment, the elementary color differences Kr12 and Kr16 and the recovered elementary color data B3 of the pixel 114a′ can be respectively represented by following equations:

Kr12=R12−G12 (29)

Kr16=R16−G16 (30)

R3=G3+(Kr12+Kr16)/2 (31)

Where, R12 and R16 are respectively predetermined elementary color data of the pixels 118b and 118a, G12 and G16 are recovered elementary color data of the pixels 118b and 118a, and the predetermined elementary color data R12 and R16 correspond to red color data, and the recovered elementary color data G12 and G16 correspond to green color data. Moreover, the recovered elementary color data G12 and G16 of the pixels 118b and 118a are calculated according to the steps shown in FIG. 4A and FIG. 4B. In detail, the recovered elementary color data G12 of the pixel 118b is calculated according to the predetermined elementary color data G9, G11, G3 and G1 of the pixels 110 surrounding the pixel 118b, and the recovered elementary color data G16 of the pixel 118a is calculated according to the predetermined elementary color data G3, G15, G19 and G7 of the pixels 110 surrounding the pixel 118a. Namely, the pixels 118b and 118a located at the upper and lower sides of the pixel 114a′ are regarded as the target pixel 112 of FIG. 1, and the recovered elementary color data G12 and G16 of the pixels 118b and 118a are calculated according to the steps shown in FIG. 4A and FIG. 4B. Since the method of calculating the recovered elementary color data G12 and G16 can be deduced according to the related descriptions of FIG. 1 and FIG. 4A-FIG. 4B, details thereof are not repeated.

Then, the elementary color differences Kr12 and Kr16 are calculated according to the predetermined elementary color data R12 and R16 of the pixels 118b and 118a and the recovered elementary color data G12 and G16 of the pixels 118b and 118a (as shown by equations (29) and (30)). Then, the recovered elementary color data R3 of the pixel 114a′ is calculated according to the elementary color differences Kr12 and Kr16 and the predetermined elementary color data G3 of the pixel 114a′.

In other words, in the image processing method of the present embodiment, the two elementary color differences Kr12 and Kr16 are calculated according to the predetermined elementary color data R12 and R16 of the pixels 118b and 118a and the recovered elementary color data G12 and G16 of the pixels 118b and 118a, where the elementary color differences Kr12 and Kr16 represent differences of red color data and green color data. Then, the recovered elementary color data R3 of the pixel 114a′ is calculated according to the predetermined elementary color data G3 of the pixel 114a′ and the elementary color differences Kr12 and Kr16 of two pixels adjacent to the pixel 114a′. In this way, the other recovered elementary color data R3 of the pixel 114a′ adjacent to the target pixel is reconstructed, and the recovered elementary color data R3 of the present embodiment, for example, corresponds to red color data. Now, the pixel 114a′ simultaneously has the red, green and blue data, and can display a full color image. In other words, according to the steps of FIG. 7, the other two elementary color data (i.e. the recovered elementary color data B3 and the recovered elementary color data R3) of a pixel (for example, the pixel 114a′) adjacent to the target pixel 112 can be reconstructed.

It should be noticed that in the image processing method of FIG. 3A and FIG. 3B, since the green data corrected by the mapping relationship and having more data amount is used to reconstruct the blue data and red data with less data amount, the image processing method of the present embodiment can improve reliability of the recovered elementary color data. Moreover, according to the related descriptions of FIG. 1 to FIG. 3B, the image processing method of the invention can also reconstruct recovered elementary color data with a larger gain.

In summary, in the embodiments of the invention, by calculating a plurality of elementary color differences of the pixels adjacent to the target pixel and using the predetermined elementary color data of the target pixel, the recovered elementary color data of the target pixel is reconstructed. In this way, image data with good quality is reconstructed. Moreover, the mapping relationship can be referred to query the component weigh value to control the interpolation image, by which the image data can be corrected to reduce unnecessary image noise, so as to improve the displayed image quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image processing method, adapted to calculate image data of a pixel array, wherein the pixel array comprises a plurality of pixels, and each of the pixels has a predetermined elementary color data, the image processing method comprising:
selecting a target pixel from the pixel array;
calculating a plurality of first elementary color differences of a plurality of first pixels adjacent to the target pixel, wherein a part of the first pixels are arranged along a first direction, and another part of the first pixels are arranged along a second direction substantially perpendicular to the first direction; and
calculating a first recovered elementary color data of the target pixel according to the first elementary color differences and the predetermined elementary color data of the target pixel.

2. The image processing method as claimed in claim 1, further comprising:
respectively calculating a first elementary color difference component of the first pixels arranged along the first direction and a second elementary color difference component of the first pixels arranged along the second direction according to the first elementary color differences; and
determining a first component weight value of the target pixel corresponding to the first elementary color difference component and the second elementary color difference component according to a mapping relationship.

3. The image processing method as claimed in claim 2, further comprising:
respectively calculating a first elementary color sum component of the first pixels arranged along the first direction and a second elementary color sum component of the first pixels arranged along the second direction according to the first elementary color differences;
adding the first elementary color sum component and the second elementary color sum component to obtain a first value, and subtracting the first elementary color sum component from the second elementary color sum component or subtracting the second elementary color sum component from the first elementary color sum component to obtain a second value;
calculating a first elementary color recovered difference of the target pixel according to the first value, the second value and the first component weight value; and
obtaining the first recovered elementary color data by adding the first elementary color recovered difference and the predetermined elementary color data of the target pixel.

4. The image processing method as claimed in claim 1, wherein each of the first elementary color differences is obtained according to the predetermined elementary color data of the corresponding first pixel and the predetermined elementary color data of two pixels located at two opposite sides of the corresponding first pixel.

5. The image processing method as claimed in claim 2, further comprising:
calculating a plurality of second elementary color differences of a plurality of second pixels adjacent to the target pixel, wherein a part of the second pixels are arranged along a third direction, and another part of the second pixels are arranged along a fourth direction substantially perpendicular to the third direction, and an acute angle is formed between the third direction and the first direction;
calculating a plurality of second recovered elementary color data of the first pixels according to the second elementary color differences of the second pixels and the predetermined elementary color data of the first pixels;
calculating a plurality of third elementary color differences of the first pixels; and
calculating a third recovered elementary color data of the target pixel according to the third elementary color differences and the first recovered elementary color data of the target pixel.

6. The image processing method as claimed in claim 5, wherein the third elementary color differences of the first pixels are obtained according to the second recovered elementary color data of the first pixels and the predetermined elementary color data of the first pixels.

7. The image processing method as claimed in claim 5, wherein the step of calculating the second elementary color differences of the second pixels comprises:
regarding each of the second pixels as the target pixel to calculate the corresponding first recovered elementary color data of each of the second pixels; and
calculating the second elementary color differences of the second pixels according to the first recovered elementary color data of the second pixels and the predetermined elementary color data of the second pixels.

8. The image processing method as claimed in claim 5, wherein the step of calculating the second recovered elementary color data of the target pixel comprises:
calculating a fourth elementary color difference of the target pixel according to the third elementary color differences; and
obtaining the second recovered elementary color data by subtracting the fourth elementary color difference from the first recovered elementary color data of the target pixel.

9. The image processing method as claimed in claim 8, wherein the step of calculating the fourth elementary color difference of the target pixel comprises:
respectively calculating a third elementary color difference component of the first pixels arranged along the first direction and a fourth elementary color difference component of the first pixels arranged along the second direction according to the third elementary color differences; and
determining a second component weight value of the target pixel corresponding to the third elementary color difference component and the fourth elementary color difference component according to a mapping relationship.

10. The image processing method as claimed in claim 9, further comprising:
calculating a third elementary color sum component of the first pixels arranged along the first direction and a fourth elementary color sum component of the first pixels arranged along the second direction according to the third elementary color differences;
adding the third elementary color sum component and the fourth elementary color sum component to obtain a third value, and subtracting the third elementary color sum component from the fourth elementary color sum component or subtracting the fourth elementary color sum component from the third elementary color sum component to obtain a fourth value; and
calculating the fourth elementary color difference of the target pixel according to the third value, the fourth value and the second component weight value.

11. The image processing method as claimed in claim 5, further comprising:
selecting one of the first pixels; and
calculating a fourth recovered elementary color data of the first pixel according to the predetermined elementary color data of the selected first pixel and two fifth elementary color differences of two pixels located at two opposite sides of the selected first pixel.

12. The image processing method as claimed in claim 9, further comprising:
respectively regarding the two pixels located at two opposite sides of the selected first pixel as the target pixel to respectively calculate the corresponding first recovered elementary color data of the two pixels; and
calculating the two fifth elementary color differences according to the predetermined elementary color data of the two pixels and the first recovered elementary color data of the two pixels.

13. The image processing method as claimed in claim 1, wherein the first recovered elementary color data corresponds to a green color data.
